(19) United States
(12) Patent Application Publication
(10) Pub. No.: US 2012/0030018 A1
(43) Pub. Date: Feb. 2, 2012

(54) Systems And Methods For Managing Electronic Content

(75) Inventors: Eric Passmore, Ashburn, VA (US); Sudhir Achuthan, Vienna, VA (US); Sean Christopher Timm, Herndon, VA (US); Travis Adam Walker, South Riding, VA (US); Vineet Mahajan, Ashburn, VA (US)

(73) Assignee: AOL Inc.

(21) Appl. No.: 12/845,307

(22) Filed: Jul. 28, 2010

(51) Int. Cl. G06F 17/30; G06Q 30/00

(52) U.S. Cl. 705/14.52; 707/754; 707/E17.059

(57) ABSTRACT

Systems and methods are disclosed for managing electronic content, such as over the Internet. One computer-implemented method for managing electronic content includes: receiving, over an electronic network, log data of activities by Internet users; filtering the log data based on at least one aspect of the activities; aggregating the filtered log data by a predetermined period of time; calculating a trend in the aggregated log data based on a change of the activities; and presenting a request to a contributor over the electronic network, the request soliciting the submission of electronic content relating to the calculated trend.

### BACKGROUND INFORMATION

1. Technical Field

The present disclosure generally relates to managing electronic content. More specifically, and without limitation, the exemplary embodiments described herein relate to systems and methods for information processing, electronic content generation, and electronic advertising, such as over the Internet.

2. Background

Currently, newspapers, magazines, and other publishers of timely textual and visual content are increasingly competing with online websites for the public's attention. Online websites that generate content (so-called “content sites”) often employ writers or “bloggers” to generate articles, podcasts, videos, and other content regarding topics that are popular at that moment. These content sites face challenges in generating the quantity and diversity of content that is desired by the public and necessary to obtain sufficient web traffic and associated advertising revenue.

First of all, some types of online content can have a low “shelf-life,” in that it can be rendered out-of-date by current events or new conventional wisdom. Online content also faces tremendous levels of competition. While traditional media only competed against a finite number of peer publications and broadcasts, new online media faces competition from thousands, or even hundreds of thousands, of websites. As a result, it is important for providers of online content to generate very large volumes of content. It can be useful to continuously generate large amounts of content about a topic to ensure that it is timely and up-to-date, as well to ensure that such content is distributed and displayed throughout the Internet, where it is likely to be consumed by online users.

In addition to the interest of generating large quantities of content, in many cases it is important for online content providers to focus on high-quality content. The above-referenced excess of competition means that online users can easily turn elsewhere if they perceive that online content is low in quality. The quality of content is also important because of the way that users find and browse content online. Many search engines deliver web pages to users based on the level of positive feedback exemplified by linking from other websites, positive comments, thumbs-ups, etc. Therefore, favorably-received content will be higher-ranked by search engines, and more likely to be displayed to users.

The need for large quantities of high-quality content is not easily satisfied by a traditional staff of editors and writers. The amount of online data received on user preferences/history, page performance, reviews, etc. is just too overwhelming for any group of people to efficiently process and leverage. The amount of content that should be generated based on high-demand topics is also too large for the limited staff of a company to create in a high-quality manner. Finally, even the most experienced editors are not always able to determine what online content will become most highly-sought-after, and calculate the monetary value of such online content.

The present disclosure is directed to addressing one or more of the above-referenced challenges by providing improved systems and methods for managing electronic content. Among other features and advantages, the disclosed embodiments include managing electronic content, determining topics in high demand, calculating the value of electronic content, and requesting electronic content from users, such as over the Internet.

### SUMMARY

In accordance with one disclosed exemplary embodiment, a computer-implemented method is disclosed for managing electronic content. The method includes: receiving, over an electronic network, log data of activities by Internet users; filtering the log data based on at least one aspect of the activities; aggregating the filtered log data by a predetermined period of time; calculating a trend concerning one or more keywords associated with the aggregated log data, based on a change in a volume of the activities; and presenting to an editor, over the electronic network, an editorial console including a topic associated with the calculated trend and metadata related to the topic.

In accordance with another disclosed exemplary embodiment, a computer-implemented method is disclosed for managing electronic content. The method includes: receiving, over an electronic network, log data of activities by Internet users, the log data including at least one of proxy data, search queries, or URLs; filtering the log data based on at least one aspect of the activities; aggregating the filtered log data by a predetermined period of time; calculating a trend concerning one or more keywords associated with the aggregated log data, by comparing a volume of the aggregated log data concerning one of the keywords to a historical volume of activities concerning the one of the keywords; and presenting to an editor, over the electronic network, an editorial console including a topic associated with the calculated trend and metadata related to the topic.

In accordance with another disclosed exemplary embodiment, a computer-implemented method is disclosed for managing electronic content. The method includes: receiving, over an electronic network, log data of activities by Internet users, the log data including at least one of proxy data, search queries, or URLs; filtering the log data based on at least one aspect of the activities; aggregating the filtered log data by a predetermined period of time; calculating a trend concerning one or more keywords associated with the aggregated log data, by comparing a volume of the aggregated log data concerning one of the keywords to a historical volume of activities concerning the one of the keywords; and presenting to an editor, over the electronic network, an editorial console including a topic associated with the calculated trend and metadata related to the topic.

In accordance with another disclosed exemplary embodiment, a system is disclosed for managing electronic content. The system includes: a server configured to receive, over an electronic network, log data of activities by Internet users, and a processor. The processor is configured to: filter the log data based on at least one aspect of the activities; aggregate the filtered log data over a predetermined period of time; and calculate a trend concerning one or more keywords associated with the aggregated log data, based on a change in a volume of the activities. The system also includes a web server configured to present to an editor, over the electronic network, an editorial console including a topic associated with the calculated trend and metadata related to the topic.

In accordance with one disclosed exemplary embodiment, a computer-implemented method is disclosed for managing electronic content. The method includes receiving, over an electronic network, log data of activities by Internet users; filtering the log data based on at least one aspect of the activities; aggregating the filtered log data over a predetermined period of time; calculating a trend concerning one or more keywords associated with the aggregated log data, wherein calculating includes analyzing a change of the Internet activities; and presenting, based on the calculated trend, a request to a contributor over the electronic network, the request soliciting the submission of electronic content relating to a topic associated with the one or more keywords.

In accordance with another disclosed exemplary embodiment, another computer-implemented method is disclosed for managing electronic content. The method includes receiving, over an electronic network, log data of activities by Internet users, the log data including at least one of proxy data, search queries, or URLs; filtering the log data based on at least one aspect of the activities; aggregating the filtered log data over a predetermined period of time; calculating a trend concerning one or more keywords associated with the aggregated log data, by comparing a volume of the aggregated log data concerning one of the keywords to a historical volume of activities concerning the one of the keywords; and presenting, based on the calculated trend, a request to a contributor over the electronic network, the request soliciting the submission of electronic content relating to a topic associated with the one or more keywords.

In accordance with another disclosed exemplary embodiment, a system is disclosed for managing electronic content. The system includes a server configured to receive, over an electronic network, log data of activities by Internet users. The system also includes a processor configured to filter the log data based on at least one aspect of the activities; aggregate the filtered log data over a predetermined period of time; and calculate a trend concerning one or more keywords associated with the aggregated log data, wherein calculating includes analyzing a change of the Internet activities. The system also includes a web server configured to present, based on the calculated trend, a request to a contributor over the electronic network, the request soliciting the submission of electronic content relating to a topic associated with the one or more keywords.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

The accompanying drawings, which are incorporated in and constitute a part of this specification, illustrate certain embodiments of the disclosure, and together with the description, serve to explain the principles of the disclosure.

As such, those skilled in the art will appreciate that the conception upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

The following figures are used to describe exemplary features and embodiments related to the present disclosure. In the figures:

FIG. 1 depicts a block diagram of an exemplary network for managing electronic content;

FIG. 2 depicts a flow diagram concerning exemplary systems for managing electronic content;

FIG. 3 depicts a flow diagram of an exemplary method of managing electronic content;

FIG. 4 depicts flow diagrams of exemplary interactions between users and contractors and the exemplary systems of FIG. 2;

FIG. 5 depicts flow diagrams of exemplary interactions between editors and the exemplary systems of FIG. 2;

FIG. 6 depicts a flow diagram of exemplary interactions between editors and the exemplary systems of FIG. 2;

FIG. 7 depicts a flow diagram of exemplary interactions between editors and the exemplary systems of FIG. 2;

FIG. 8 depicts a flow diagram of exemplary interactions between contributors and the exemplary systems of FIG. 2;

FIG. 9 depicts a flow diagram of exemplary interactions between contributors and the exemplary systems of FIG. 2;

FIG. 10 depicts a flow diagram of an exemplary method for registering contributors with the exemplary systems of FIG. 2;

FIG. 11 depicts a block diagram of an exemplary demand system for analyzing electronic content;

FIG. 12 depicts a flow diagram of an exemplary demand method for analyzing electronic content;

FIG. 13 depicts an exemplary click graph for categorizing queries;

FIG. 14 is a screen shot of an exemplary set of reactive terms generated by a demand system;

FIG. 15 is a screen shot of an exemplary set of evergreen terms generated by a demand system;

FIG. 16 is a screen shot of an exemplary set of news trending terms generated by a demand system;

FIG. 17 is a screen shot of an exemplary set of recent trending terms generated by a demand system;

FIG. 18 is a screen shot of a graph of one exemplary trending term tracked by a demand system;

FIG. 19 is a screen shot of a related terms, categories, description, related questions & superlatives, and top clicked URLS associated with the exemplary trending term tracked by a demand system;

FIG. 20 is a screen shot of headlines and messages associated with the exemplary trending term tracked by a demand system;

FIG. 21 is a screen shot of videos and headlines associated with the exemplary trending term tracked by a demand system;

FIG. 22 is a screen shot of an exemplary calendaring console generated by a demand system; and

FIG. 23 is a screen shot of an exemplary content request generated by a demand system.

### DETAILED DESCRIPTION

Reference will now be made in detail to exemplary embodiments of the disclosure, examples of which are illustrated in the accompanying drawings. Wherever possible, the same reference numbers will be used throughout the drawings to refer to the same or like parts.

Embodiments of the present disclosure are related to managing electronic content, including online content that is generated by users, which is often referred to as “user generated content” (i.e., “UGC”). Electronic content may generally include any type or combination of text, images, audio tracks, video tracks, or computer programs. For example, electronic content may include articles, blog posts, photos, recordings, videos, software, and/or games created by anyone in the world. In one embodiment, it may be desirable for users to submit online content to a network where it may be analyzed, manipulated, and/or distributed throughout the Internet. Although referred to interchangeably herein as “electronic content,” “online content,” or “UGC,” such content may or may not be associated with the Internet. For example, content may be created, analyzed, and/or delivered over any network, such as a mobile phone network, cable television network, satellite network, or device network. Consistent with the present disclosure, management of electronic content may include one or more of: receiving online user data, receiving web data, receiving user-web interaction data, identifying electronic content, receiving electronic content, analyzing electronic content, manipulating electronic content, distributing electronic content, and communicating with users regarding electronic content, among other things.

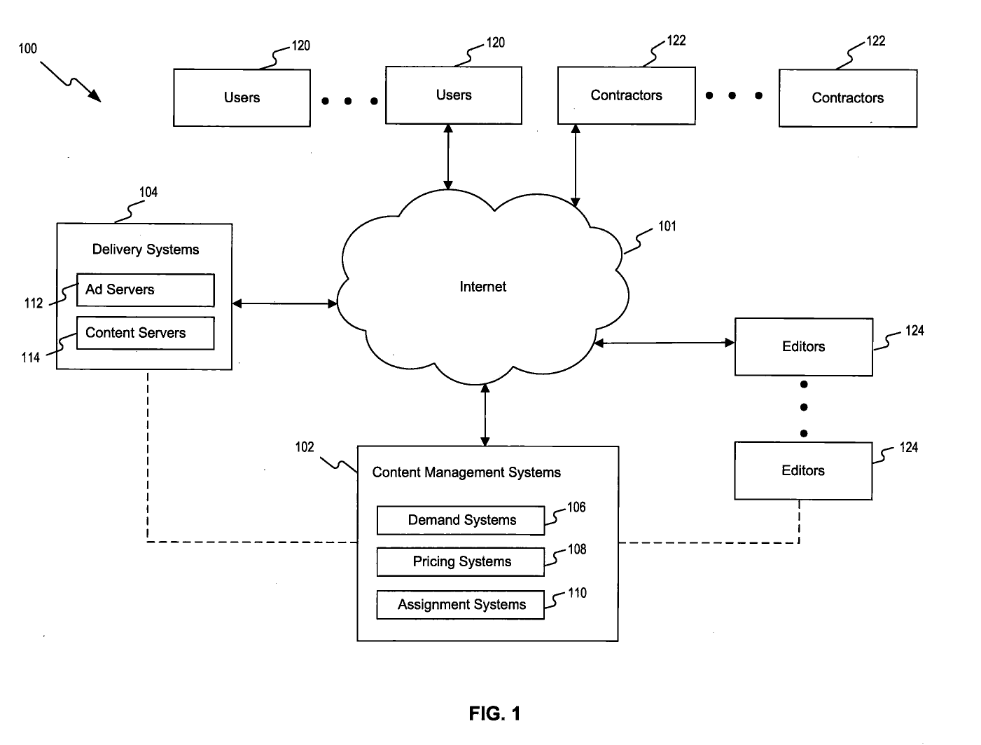

FIG. 1 illustrates an exemplary network 100 in which electronic content may be managed. Network 100 may include a plurality of content management systems 102 and delivery systems 104 provided in communication with the Internet 101. Content management systems 102 and delivery systems 104 may generally include a plurality of server systems and databases connected to the Internet. In one embodiment, content management systems 102 may include one or more demand systems 106, pricing systems 108, and assignment systems 110. Demand systems 106 may generally determine topics about which online content should be generated, and characteristics that should be included in the content (e.g., a photo of the Kennedy Center that is at least 800×600 resolution). Pricing systems 108 may generally determine how valuable content is, and what amount of money to pay for it (e.g., $125 for a photo of the Kennedy Center because it will generate about 10,000 clicks per month). Assignment systems 110 may generally determine which users of the Internet may generate and submit such desirable content (e.g., a Kennedy Center photo request should be sent to User X because he enjoys photography and lives within 10 miles of the Kennedy Center).

In one embodiment, delivery systems 104 may include advertising delivery servers 112 and content delivery servers 114. Advertising delivery servers 112 may control the display of ads at desired times to desired Internet users on desired web pages, so as to maximize advertiser interests, user experiences, and/or advertising revenue. Content delivery servers 114 may control the display of online content at desired times to desired Internet users on desired web pages so as to maximize user experiences and/or advertising revenue. Advertising and content delivery servers 112, 114 may be configured to communicate with each other, and in some embodiments they may be fully-integrated. For example, ads and content may be selectively matched with each other in real-time based on the identify of a user, a website/link/content requested by the user, time of day, web history, preferences, etc., as will be described in more detail below. For instance, delivery systems 104 may interact with ad servers or other remote web servers configured to receive advertising information from advertisers and serve ads on websites publishing user generated content. Ad servers may serve ads based on contextual targeting of websites, search results, advertiser information and/or user profile information. Such ad servers may be configured to generate behavioral logs, leadback logs, click logs, action logs, conversion logs, and/or impression logs, based on users' interactions with websites and/or ads.

Network 100 may also include a plurality of users 120, contractors 122, and/or editors 124 located anywhere in the world in communication with the Internet 101 or any other communications network. Users 120, contractors 122, and editors 124 may be any person or entity using computers, personal digital assistants (“PDAs”), smartphones, mobile devices, Internet-enabled televisions, automobiles, or homes, or any other mobile or electronic device configured to access the Internet 101.

Users 120 may be any person or entity with access to the Internet 101, but not necessarily an existing relationship to content management systems 102. Thus, the term “user” may refer to, for example, any consumer, viewer, or visitor of a web page or website, and can also refer to the aggregation of individual users into certain groupings. References to users “viewing” content and/or ads is meant to include any presentation, whether visual, aural, tactile, or a combination thereof. In another embodiment, users may be a subset of Internet users defined by their membership in a network associated with content management systems 102. For example, users 120 may be provided with a username and password by which they may log-in to a network website. The network may retain a set of attributes associated with each user, in a searchable profile. The attributes may reflect the user's interests and incorporate characteristics that impact content and advertisement selection, purchasing, and other online behavior. Attributes may be created based on user data, such as impression history, click history, purchase history, demographic data, submission history, preferences, etc., any of which may be user-supplied.

Contractors 122 may include any person or entity who has a contractual relationship with a network of content management systems 102. For example, contractors 122 may be regular contributors of online content, such as paid writers, photographers, videographers, artists, temp workers, contract workers, and/or full-time employees of the network. Contractors 122 may contribute content to the network on a regular or semi-regular basis.

Editors 124 may include any person or entity who performs editorial tasks for content management systems 102. Editors 124 may perform one or more aspects of online content management, such as, analyzing demand for content, writing and distributing requests for content (i.e., “assignments), reviewing submitted content, and pricing content. In one embodiment, editors 124 may be in communication with content management systems 102, so they may access and/or influence demand, pricing, and assignment functions. Alternatively, editors 124 may be omitted, with their functions or roles performed by content management systems 102 and/or delivery systems 104. In another embodiment, editors 124 may supplement and/or review content management system functions.

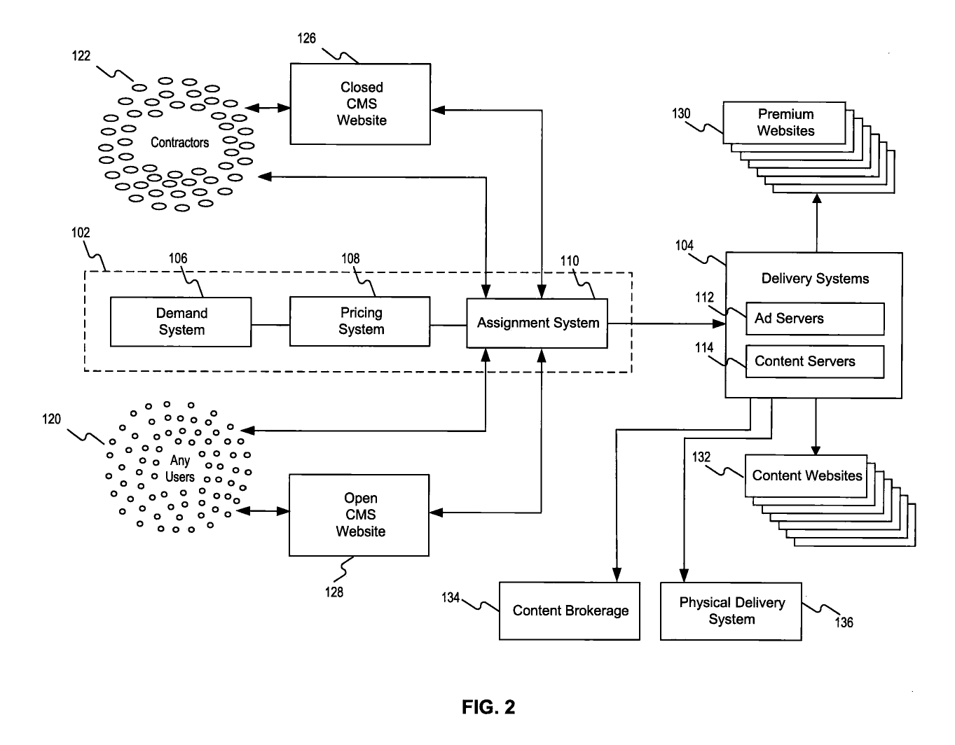

FIG. 2 depicts a flow diagram concerning content management systems 102 and delivery systems 104. Generally, contractors 122 may interact with a closed content management system website 126, which is accessible only to contractors 122 and editors 124. Users 120 may interact with an open content management system website 128, which is accessible by anyone with a connection to the Internet. Websites 126, 128 may be part of, and facilitate human interaction with other components of, content management systems 102, including demand systems 106, pricing systems 108, and assignment systems 110.

Each demand system 106 may be configured to determine topics about which online content should be generated, and desired characteristics of that online content. As will be described in more detail below, demand system 106 may be configured to receive raw log data of Internet user activities, filter the log data based on one or more aspects of the activities, aggregate the filtered log data by day or time, and calculate trends in the aggregated log data based on a rate of change of the activities. Demand system 106 may therefore be configured to generate lists of trending topics, populate an editorial console with lists of trending topics and related “trend metadata,” and automatically generate requests for content, based on the calculated trends. Demand system 106 may be configured to pass such information to one or more pricing systems 108.

Each pricing system 108 may be configured to evaluate content or proposed content, calculate the value of the content, and determine how much money to pay to contractors 122 or users 120 for the content. In one embodiment, pricing system 108 may calculate how much content would be worth if generated by contractors 122 or users 120, based on the type of content, the subject matter, topic, requested quality or characteristics, and/or proposed contributor, etc. In another embodiment, pricing system 108 may evaluate content again once it is submitted, or only after it is submitted. Pricing system 108 may be configured to pass information to assignment system 110.

Each assignment system 110 may be configured to determine whether the content should be generated by contractors 122, users 120, or contractors and users. Assignment system 110 may also be configured to determine which particular contractor(s) or user(s) to send content requests to. In one embodiment, assignment system 110 may post content requests to one or both of the closed and open content management system websites 126, 128, where people can view the content requests. Assignment system 110 may also be configured to generate and send requests for online content directly to one or more contractors 122 or users 120, via any desirable communication technique, including but not limited to: telephone, facsimile, email, SMS or MMS text message, social networking message, VOIP, website, podcast, chat room, message board, listserv, media stream, electronic broadcast, etc.

Contractors 122 and users 120 will sometimes be referred to in this disclosure generally as “contributors.” In general, contributors may be asked to generate content in response to content requests. For example, contributors may write articles, stories, blog posts, reviews, books, or other text information. They may also create photographs, artwork, audio tracks, videos, links, software, websites, or any other multimedia content. Contributors may upload or otherwise submit the content they create via the closed and open content management system websites 126, 128, depending on whether they are users or contractors.

Content that is submitted by contributors through content management systems 102 may be passed to delivery systems 104, where it may be further evaluated, matched with desired advertisements and/or campaigns, and then distributed onto websites where it may be displayed to anyone viewing the Internet. Delivery systems 104 may also deliver advertising and content to people directly over any type of network, such as a mobile phone network, television network, satellite network, or device network.

In one embodiment, delivery systems 104 may distribute content either to premium websites 130 or content websites 132. Premium websites 130 may be websites that receive a large volume of traffic (i.e., clicks, views, impressions). For example, premium websites 130 may include sites referenced by or incorporated in a web portal or search engine. Premium websites 130 may also include popular blogs that have relatively high name recognition and site traffic. By contrast, content websites 132 may include a collection of content web pages that are generally less well-known and less visited. In one embodiment, content may be distributed first to one or more content websites 132 where its response by web users is evaluated, and then it may be moved to one or more premium websites 130 if it surpasses a minimum threshold of popularity. Advertisements may be matched with content on any website, whether premium or evergreen, based on subject matter, timing, etc. In one embodiment, contributors may receive a portion of advertising revenue associated with advertisements displayed with the contributors' submitted content.

In one embodiment, delivery systems 104 may also or alternatively distribute content through a content brokerage 134, which may be an electronic platform for offering, bidding on, licensing, and/or purchasing electronic content in a free-market environment. Delivery systems 104 may also distribute content to traditional physical delivery systems 136, such as newspaper or magazine circulation systems.

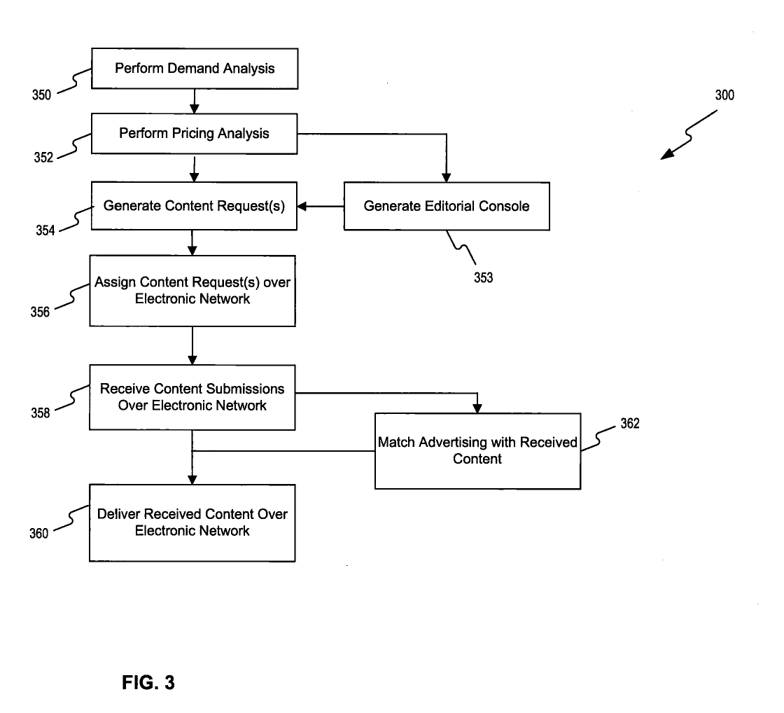

The above-described network 100 and systems 102, 104 may be used to perform various methods of managing online content in ways that improve Internet users' online experiences, increase the amount and quality of relevant online content, and maximize network web traffic and advertising revenue. FIG. 3 depicts a flow chart of one such exemplary method 300 for managing online content. Method 300 may include performing a demand analysis (step 350). For instance, demand system 106 may analyze information from web traffic, user behavior/preferences, external sources, etc. to determine what content is in high-demand. Demand system 106 may then generate content requests that indicate a type of content requested, and if desired, characteristics of such content. Method 300 may also include performing a pricing analysis of content (step 352). For example, pricing system 108 may determine the value of online content created based on content requests generated by demand system 106. In one embodiment, pricing system 108 may determine the value of content based on the predicted web traffic and/or advertising revenue associated with the content, over a given period of time.

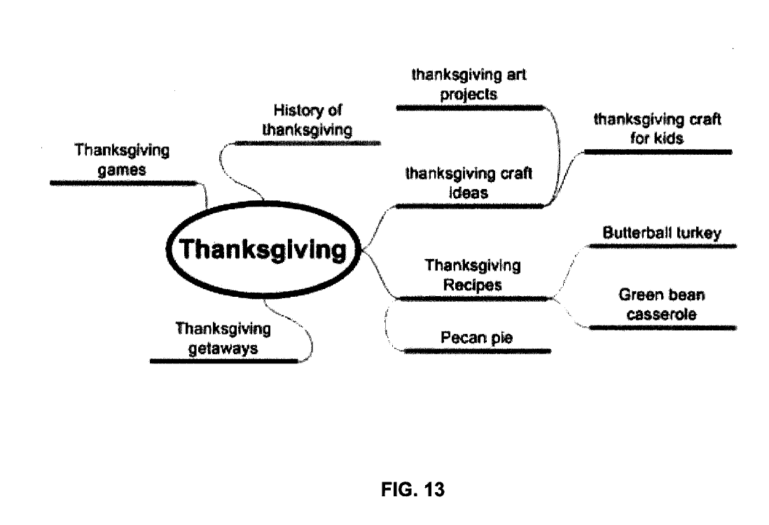

Method 300 may also include generating an editorial console based on outputs of demand system 106 and/or pricing system 108 (step 353). Such an editorial console may provide editors with lists of trends, categories of trends, and so-called “trend metadata,” which may include additional information aggregated from across the Internet regarding each trend. As an example, demand system 106 and/or pricing system 108 may generate an editorial console including a list of trending terms, related search terms, related questions and superlatives, related news stories, related videos, etc., as will be described in more detail with respect to FIGS. 13-21.

Method 300 may also include automatically generating one or more content requests based on the demand and pricing analyses (step 354). For example, method 350 may include generating an electronic data file that includes a content topic, a headline, a content description, a due date, a price, suggested characteristics, and/or required characteristics. Method 300 may also include assigning content requests over an electronic network (step 356). For example, assignment system 110 may determine, based on the substance of generated content requests and knowledge about various contributors, which contributors to request content from and how to request content from those contributors. In one embodiment, assignment system 110 may assign content requests to contributors or users via email, text message, or any other network communication message.

Method 300 may also include receiving content submissions from contributors over an electronic network (step 358). For example, assignment system 110 or delivery systems 104 may receive uploaded content files from contributors over the Internet, and editors may selectively edit or otherwise manipulate the content, as desired. Method 300 may also include delivering received content over an electronic network (step 360). For example, delivery systems 104 may deliver content to one or more websites, web pages, blogs, mobile devices, software platforms, broadcasts, etc.

In one embodiment, method 300 may match advertising with received content (step 362) before delivering the content and advertising over an electronic network. For example, advertising delivery servers 112 and/or content delivery servers 114 may match advertising, such as banner ads, commercials, watermarks, text ads, etc. to the content before it is delivered throughout the Internet, which may improve the amount of value obtained by advertisers, and increase the amount advertisers are willing to pay for advertising. Of course, assignments and/or content may also be delivered through traditional mechanisms, such as telephone, facsimile, printed communications, etc.

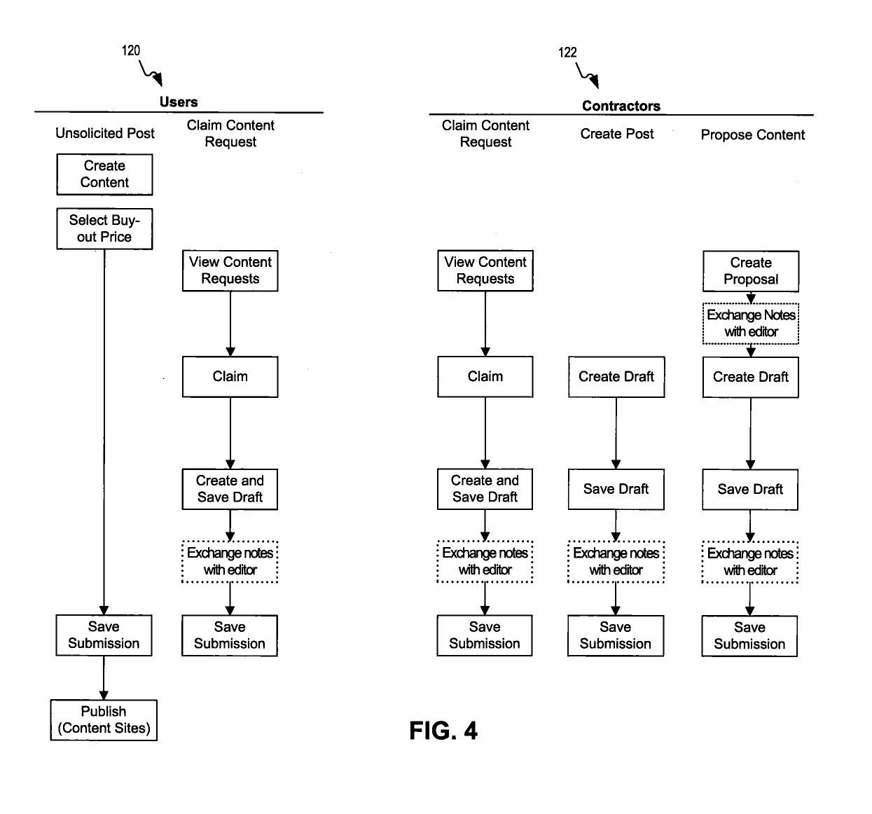

FIG. 4 depicts various exemplary process flows for interacting with content management systems 102, from the perspective of users 120 and contractors 122. It will be appreciated that these process flows are merely exemplary of the interaction possible with content management systems 102, and should not be construed as limiting of the scope of the capabilities and functionality of content management systems 102.

In one embodiment, in the event that a user 120 desires to create an unsolicited post for submission to content management systems 102, a user may use open CMS website 128 to create content, e.g., by generating a piece of electronic content that can be delivered online. The user may also select a buy-out price at which the user would be willing to sell the content. The user may save the submission, and then publish the submission, e.g., to content websites 132. Alternatively, if a user 120 desires to claim an existing content request, the user may view available content requests, claim a content request, create and save a draft, optionally exchange notes with an editor regarding the draft, and save the submission.

In addition, in the event that a contractor 122 desires to claim a content request, the contractor may use open CMS website 128 to view content requests, claim a content request, create and save a draft, optionally exchange notes with an editor, and save the submission. If a contractor 122 desires to create his or her own post, the contractor may create a draft, save the draft, optionally exchange notes with an editor, and save the submission. If a contractor 122 desires to propose content, the contractor may use open CMS website 128 to create a proposal for content, optionally exchange notes with an editor, create a draft, save the draft, optionally exchange notes with an editor, and save the submission.

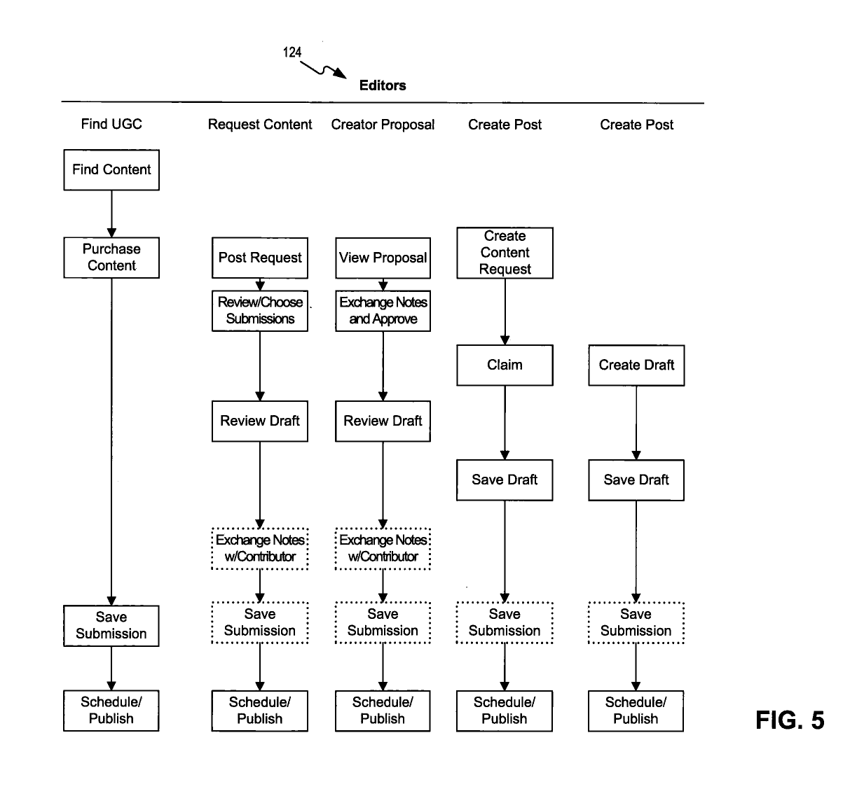

FIG. 5 depicts various exemplary process flows for interacting with content management systems 102 from the perspective of editors 124. Again, it will be appreciated that these process flows are merely exemplary of the interaction possible with content management systems 102, and should not be construed as limiting of the scope of the capabilities and functionality of content management systems 102.

In one embodiment, an editor 124 may use closed CMS website 126 to find user generated content (“UGC”) somewhere on the Internet, purchase the content, save the content as a submission, and then schedule the publishing of the content. If the editor desires to create a content request, the editor may use closed CMS website 126 to create and post the content request, review and choose submissions, review a draft of a chosen submission, optionally exchange notes with the contributor, save the submission, and schedule the submission for publishing. If a contributor has proposed the content, an editor may view the proposal, exchange notes and approve the proposal, review a draft submission, optionally exchange notes with the contributor, save the submission, and schedule the submission for publication. If an editor desires to actually submit content in a post, the editor may use closed CMS website 126 to create a content request, claim the content request, save a draft of content satisfying the content request, save the draft as a submission, and schedule the submission for publication. Alternatively, the editor may use closed CMS website 126 to simply create a draft of the content, save the draft, save the draft as a submission, and schedule the submission for publication.

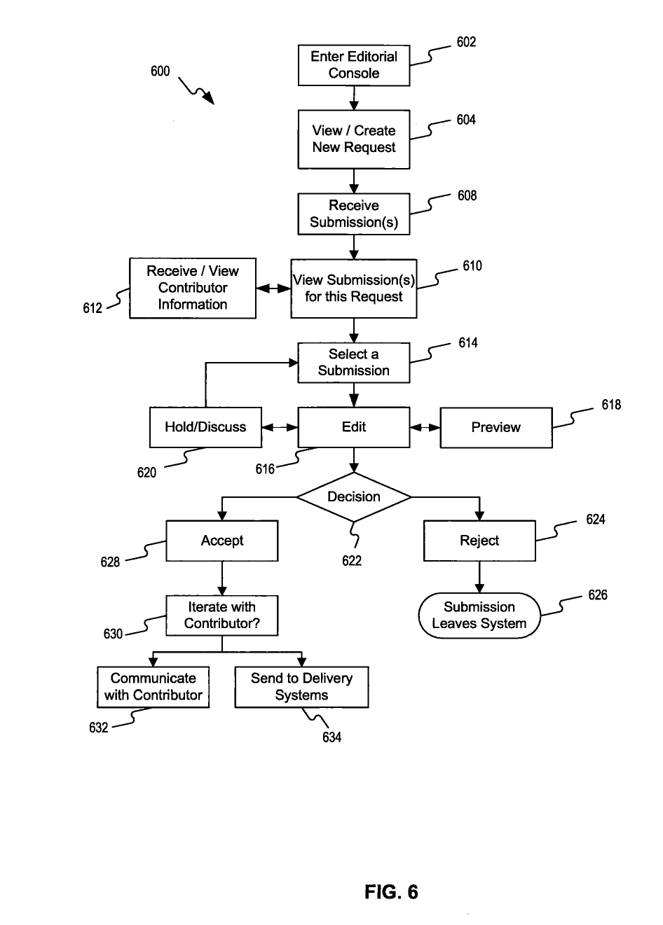

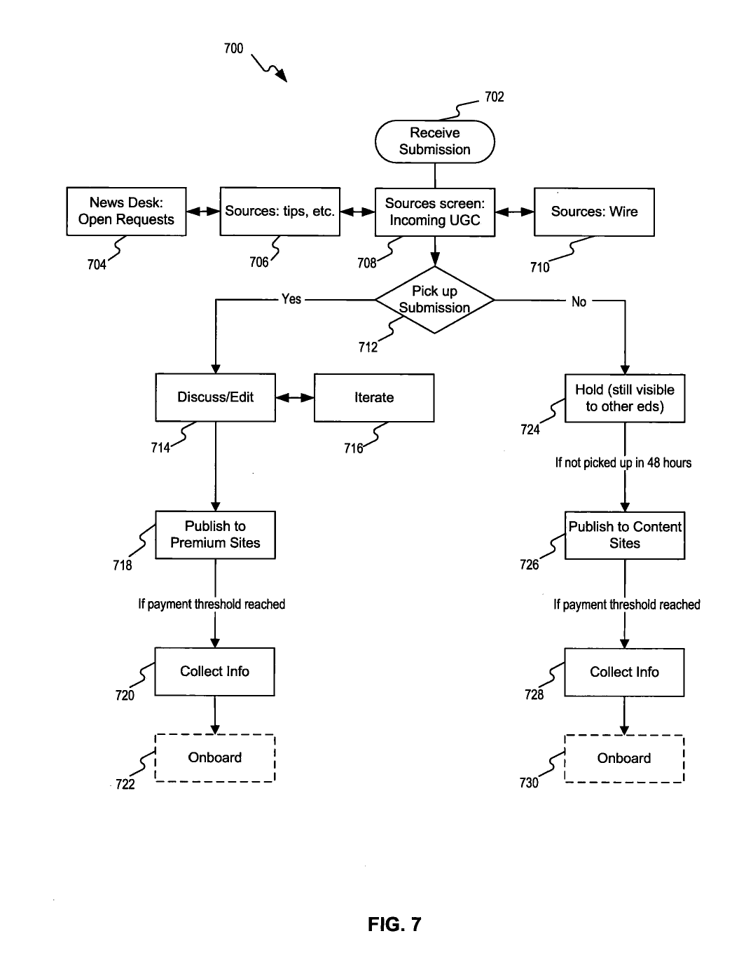

FIGS. 6 and 7 depict flowcharts of exemplary methods for managing electronic content, from an editorial perspective. FIG. 6 depicts a flow diagram of an exemplary method 600 for managing content based on a new content request. Method 600 may include entering an editorial console (step 602), such as a closed CMS website 126 or another editor-specific web portal. Method 600 may further include viewing or creating a new content request (step 604). The new content request may include a description, title, submission type (e.g., article, image, video, etc.), contributor characteristics (e.g., location, specialties, knowledge, etc.), contributor preference (e.g., user, blogger, contractor, etc.), maximum number of claims (i.e., number of people who may answer the content request), price offered for suitable submission, word count/length, due date/time, desired metatags, and/or associated URL, among other things. Method 600 may then include receiving one or more submissions from contributors (step 608), such as through the open CMS website 128 or closed CMS website 126. Method 600 may then include viewing and evaluating submissions received in relation to the content request (step 610), and optionally receiving and viewing contributor information (step 612). For example, in addition to evaluating submissions for quality, accuracy, etc., an editor may consider a contributor's reputation, track-record, location, etc.

Method 600 may then include selecting a submission based on any desired factors (step 614), such as quality, anticipated clicks or revenue, etc. Method 600 may then include editing the submission (step 616), previewing the submission as it would appear on a website (step 618), and/or holding the submission for further discussion (step 620), any of which may result in returning to select a new submission (step 614).

Method 600 may then include deciding whether to accept or reject the submission (step 622). The submission may be rejected (step 624), in which case the submission is deleted from the system and no longer considered (step 626). Alternatively, method 600 may include accepting a submission (step 628), and deciding whether to iterate with the contributor (step 630), to further edit and refine the submission. If additional iterations of editing are desired, an editor may communicate with a contributor (step 632) to further revise the submission. If the submission is ready for publication, then an editor may send the submission to delivery systems 104 (step 634).

FIG. 7 depicts a flow chart of another exemplary method 700 for receiving submissions of electronic content (step 702). In one embodiment, editors may be provided with one or more sources screens in an editorial console of closed CMS website 126, which may display available content from various sources. For example, a “News Desk” screen may display open content requests that have been fulfilled (step 704), a “Tips” screen may show unsolicited content characterized as tips (step 706), an “Incoming UGC” screen may show unsolicited content that has been submitted by users (step 708), and a “Wire” screen may display a news feed from an external source (step 710). For example, external sources may include primary event alerts, such as earthquake notification alerts, Amber Alerts, volcano eruptions, traffic alerts, disease outbreak alerts, etc. Presented with incoming content from such diverse sources, an editor may selectively pick-up any submissions of content from any of the sources for publication (step 712). If the content is to be picked up for publishing to premium sites (step 712: yes), method 700 may include discussing and/or editing the content (step 714), and optionally iterating with a contributor of the content (step 716). Method 700 may then include publishing the content, such as to one of premium websites 130 (step 718). If a payment threshold is reached (i.e., a premium site purchases the content and/or the content receives a threshold level of web traffic), then method 700 may include collecting information from the contributor (step 720), and optionally onboarding or signing-up the contributor to receive one or more payments associated with the content (step 722). If the content is not sufficient for picking up for premium sites (step 712: no), then method 700 may include holding the content for a predetermined period, such as 48 hours (step 724), while it may remain visible to other editors who may pick-up the content for a premium site. If the content is not selected by another editor for a premium site, then method 700 may include publishing the content on content websites 132 (step 726). If a payment threshold is reached (i.e., the content is receiving a predetermined minimum of traffic on the evergreen site, and/or associated advertising revenue), then method 700 may include collecting information from the contributor (step 728), and optionally onboarding the contributor to receive one or more payments associated with the content (step 730).

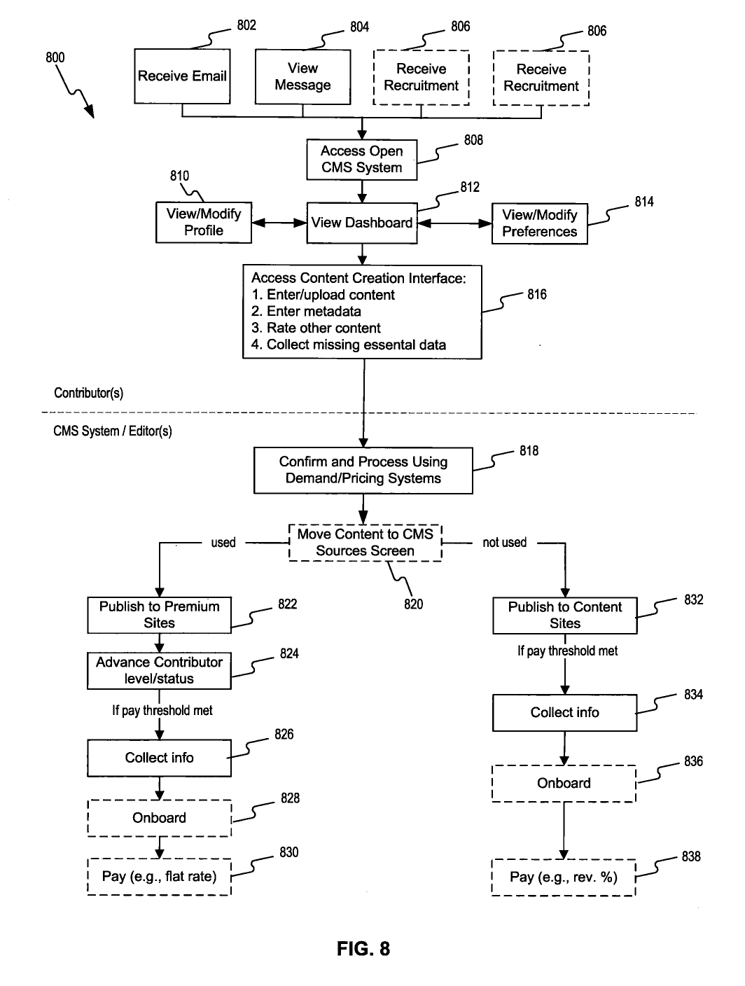

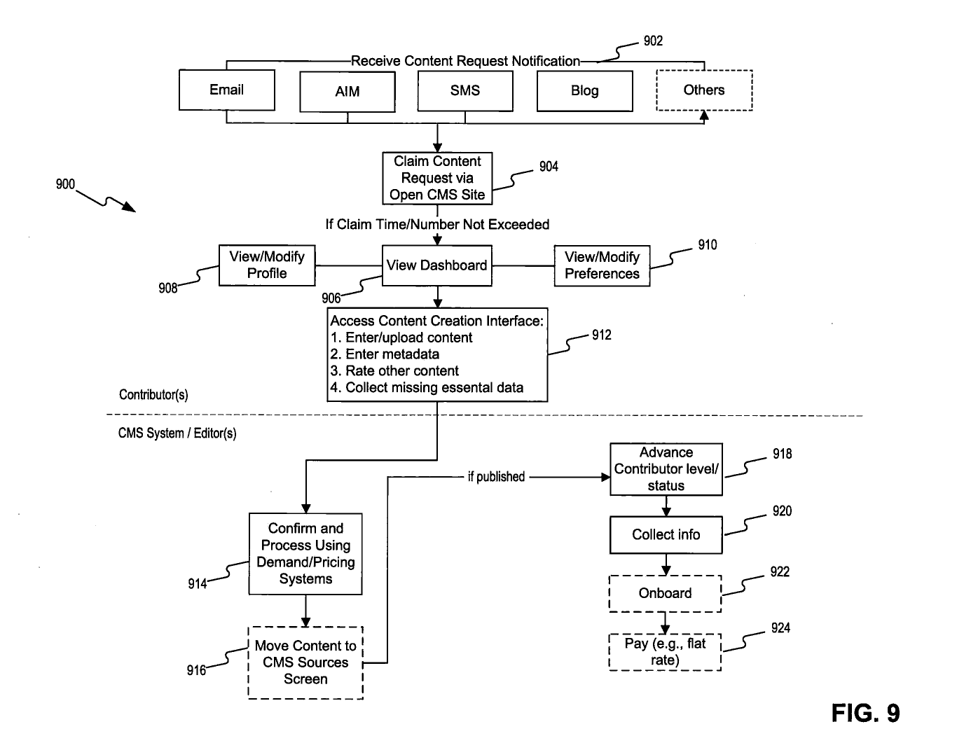

FIGS. 8 and 9 depict flowcharts of exemplary methods for interacting with content management systems 102, from the perspective of contributors. FIG. 8 depicts an exemplary method 800 for creating unsolicited content, while FIG. 9 depicts an exemplary method 900 for responding to a request for content.

Referring now to FIG. 8, method 800 may include receiving some type of information about content management systems 102, such as by email (step 802), a message displayed during commenting (step 804), or any other recruiting techniques (step 806). Method 800 may then involve a contributor accessing CMS systems 102 via open CMS website 128 (step 808). Method 800 may include the contributor viewing a dashboard (step 812), such as a web portal or console displaying available and/or pending content requests, published content status, payments received, etc. Method 800 may also include the contributor viewing and/or modifying the contributor's profile (step 810), which may include hobbies, interests, location, camera information, etc. Method 800 may also include the contributor viewing and/or modifying the contributor's preferences (step 814), which may include notification means, payment options, etc. Method 800 may include the contributor accessing and interacting with a content creation interface (step 816). For example, a contributor may enter and/or upload content, such as text, audio files, video files, software, etc., enter metadata, rate other content, and/or collect missing essential data.

Upon the submission of content by a contributor, CMS systems 102 and/or editors 124 may confirm and process the submission using demand system 106 and/or pricing system 108 (step 818). Confirmation may include displaying rights policies, payment policies, confirmation of use, etc. Processing by demand system 106 may include analyzing the level of consumer demand associated with viewing such content. Processing by pricing system 108 may include analyzing the amount of revenue that could be generated by delivering such content to various locations of the Internet in various frequencies/durations. Method 800 may further include moving the content to a CMS sources screen (step 820), where it may be evaluated by editors 124, as described with respect to FIGS. 6 and 7.

If the content is to be picked up for publishing to premium sites (step 820: “used”), method 800 may include publishing the content, such as to one of premium websites 130 (step 822), and giving credit to the contributor (step 824). If a payment threshold is reached (i.e., a premium site purchases the content and/or the content receives a threshold level of web traffic), then method 800 may include collecting information from the contributor (step 826), and optionally onboarding or signing-up the contributor to receive one or more payments associated with the content (step 828). Method 800 may include paying the contributor (step 830) a flat rate for the content, with the flat rate being determined by pricing system 108 to be less than a lifetime value of the content. If the content is not sufficient for picking up for premium sites (step 820: not used), then method 800 may include publishing the content on content websites 132 (step 832). If a payment threshold is reached (i.e., the content is receiving a predetermined minimum of traffic on the content site, and/or associated advertising revenue), then method 800 may include collecting information from the contributor (step 834), optionally onboarding the contributor to receive one or more payments associated with the content (step 836), and paying the contributor (step 838) for a share of advertising proceeds associated with displaying the content on content websites 132, such as paying the contributor a percentage of the advertising revenue generated by the content.

FIG. 9 depicts a flowchart of an exemplary method 900 for contributors to respond to content requests assigned by assignment systems 110. For example, as described above with respect to FIGS. 1 and 2, assignment systems 110 may assign content requests to users by any desired communications means. Thus, method 900 may involve a contributor receiving a notification of a content request from any type of communication system (step 902), such as email, instant message (e.g., AIM), SMS message, blog, etc. Method 900 may further include claiming a content request (step 904), such that a contributor may create and upload relevant content, and if desired, prevent other contributors from claiming the same content request (although it may be possible to allow a predefined or even unlimited number of contributors to claim a content request). Method 900 may include the contributor viewing a dashboard of open CMS site 128 (step 906), where available and/or pending content requests, published content status, payments received, etc. may be displayed. Method 900 may also include the contributor viewing and/or modifying the contributor's profile (step 908), which may include hobbies, interests, location, camera information, etc. Method 900 may also include the contributor viewing and/or modifying the contributor's preferences (step 910), which may include notification means, payment options, etc. Method 900 may include the contributor accessing and interacting with a content creation interface (step 912). For example, a contributor may enter and/or upload content, such as text, audio files, video files, software, etc., enter metadata, rate other content, and/or collect missing essential data.

Upon the submission of content by a contributor, CMS systems 102 and/or editors 124 may confirm and process the submission using demand system 106 and/or pricing system 108 (step 914). For example, demand system 106 may be used to analyze the level of consumer demand associated with viewing such content, and/or pricing system 108 may be used to analyze the amount of revenue that could be generated by delivering such content to various locations of the Internet in various frequencies/durations. Method 900 may further include moving the content to a CMS sources screen (step 916), as described with respect to FIGS. 6 and 7. If the content is to be picked up for publishing to premium sites, method 900 may include advancing a level or other status associated with the contributor (step 918), and collecting information from the contributor (step 920). Method 900 may also include onboarding or signing-up the contributor to receive one or more payments associated with the content (step 922), and paying the contributor a flat rate for the content, with the flat rate being determined by pricing system 108 to be less than a lifetime value of the content (step 924).

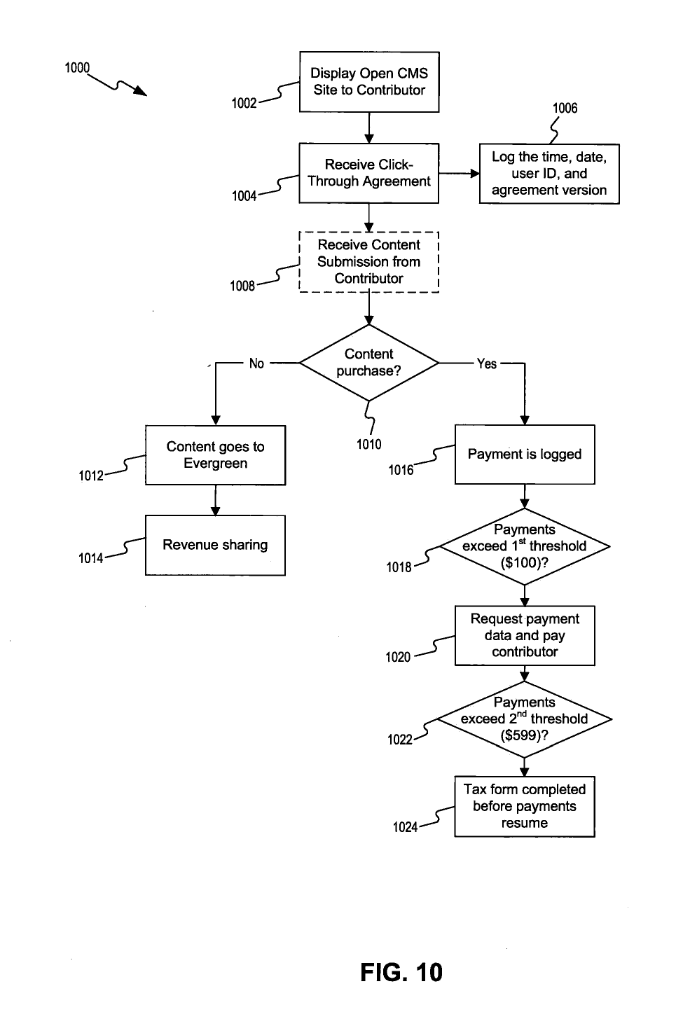

FIG. 10 depicts a flowchart of an exemplary method 1000 for onboarding a contributor to receive payments associated with submitting electronic content. Method 1000 may include displaying open CMS website 128 to a contributor (step 1002), and receiving from the contributor an expression of agreement to a click-through agreement (step 1004). In one embodiment, method 1000 may log the time, date, user ID, and agreement version of the click-through agreement (step 1006). Method 1000 may further include receiving a content submission from a contributor (step 1008) and deciding whether to purchase the content (step 1010). If the content is not purchased (step 1010: no), the content may be published to content websites 132 (step 1012), which may initiate a revenue sharing regime (step 1014), as described above. If the content is purchased (step 1010: yes), then a payment for the content may be logged (step 1016). If the payments exceed a first threshold, such as $100 (step 1018), then method 1000 may involve requesting payment data and paying the contributor (step 1020). If the payments exceed a second threshold, such as $599 (step 1022), then method 1000 may include completing an appropriate tax or income form before payments continue (step 1024).

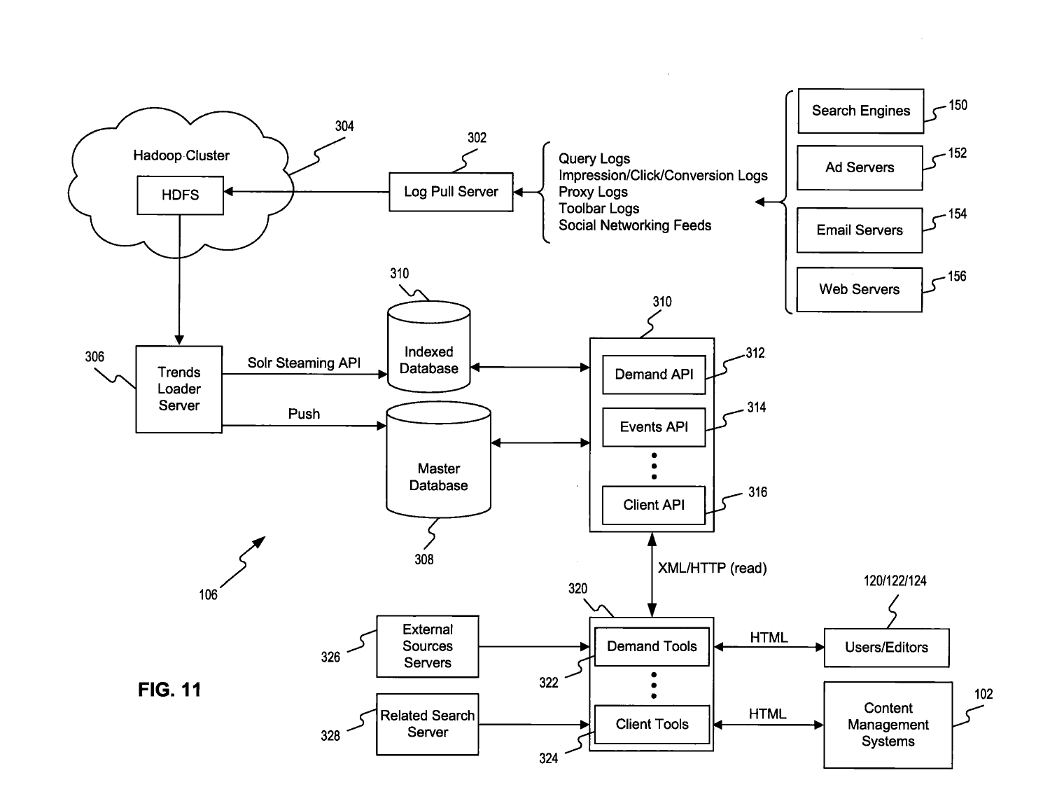

FIG. 11 depicts an exemplary embodiment of demand system 106, which may be a component of content management systems 102 (see, for example, FIGS. 1 and 2). In general, demand system 106 may include one or more server systems, databases, and/or computing systems configured to receive information from entities in network 100, process the information, and communicate the information with other entities in network 100, according to the exemplary embodiments described herein. More specifically, demand system 106 may be configured to receive data over the Internet, process/analyze the data to identify content topics of interest to users of the Internet, and present the processed/analyzed data to editors through an editor portal and/or to contributors in the form of content requests.

In one embodiment, various components of demand system 106 may include an assembly of hardware, software, and/or firmware, including a memory, a central processing unit (“CPU”), and/or a user interface. Memory may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

It will be appreciated that any suitable configuration of processors and data storage devices may be selected to carry out the embodiments of demand system 106. The hardware associated with demand system 106 may be selected to enable quick response to various business needs, relatively fast prototyping, and delivery of high-quality solutions and results. An emphasis may be placed on achieving high performance through scaling on a distributed architecture. The selected hardware may be flexible, to allow for quick reconfiguration, repurposing, and prototyping for research purposes. The data flows and processes described herein are merely exemplary, and may be reconfigured, merged, compartmentalized, and combined as desired. The exemplary modular architecture described herein may be desirable for performing data intensive analysis. A modular architecture may also be desired to enable efficient integration with external platforms, such as content analysis systems, various plug-ins and services, etc. Finally, the exemplary hardware and modular architecture may be provided with various system monitoring, reporting, and troubleshooting tools.

As described above, demand system 106 may be configured to receive data over the Internet, process/analyze the data to identify content topics of interest to users of the Internet, and present the processed/analyzed data to editors through an editor portal and/or to contributors in the form of content requests. For example, in one embodiment, an operator of demand system 106 may operate one or more search engines 150, one or more ad servers 152, one or more emails servers 154, and/or one or more web servers 156, for the purpose of running web portals, content sites, toolbars, webmail systems, etc. for consumers or other users of the Internet. In certain embodiments, search engines 150, ad servers 152, emails servers 154, and/or web servers 156 may be configured to generate query logs (i.e., data about search queries), impression/click/conversion logs (i.e., data about views, clicks, and purchases associated with various ads or websites), proxy logs (i.e., data about searches, web interaction, and/or user information collected from a web portal offered by the operator of CMS systems 102), toolbar logs (i.e., data about searches, web interaction, user information collected from a browser toolbar), and social networking feeds (i.e., data generated from a social networking web server), among other data feeds and files. For example, in one embodiment toolbars offered to consumers by an operator of CMS systems 102 may be implemented in Internet users' browsers, and log URLs visited, user IDs, queries, landing pages, times, IP addresses, zipcode, etc., which may be stored in toolbar logs. It will be appreciated that query logs, impression/click/conversion logs, proxy logs, toolbar logs, and social networking feeds may reflect the activities of users on the Internet and provide a broad source of information about content topics of interest on the Internet.

In one embodiment, demand system 106 may include a log pull server 302, which may be configured to receive any query logs, impression/click/conversion logs, proxy logs, toolbar logs, and/or social networking feeds generated by one or more of search engines 150, ad servers 152, email servers 154, and web servers 156. Log pull server 302 may compile such information and send it to a Hadoop cluster 304 for processing and analytics.

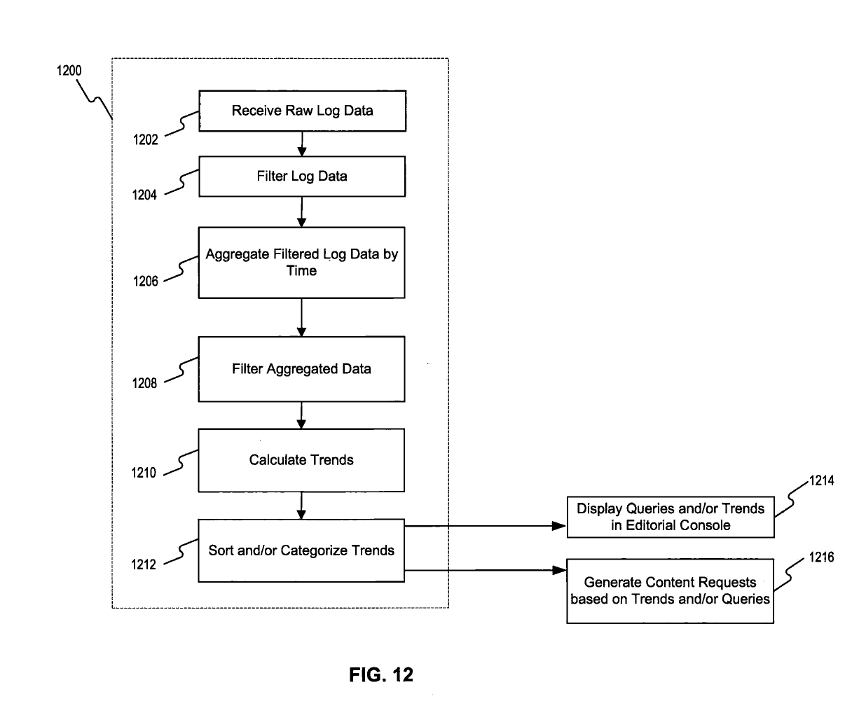

In one embodiment, Hadoop cluster 304 may include a Hadoop distributed file system (“HDFS”) that is configured to stage input data, perform data processing, and store large-volume data output. It will be appreciated that the HDFS may include any desired number or arrangement of clustered machines, as needed to provide suitable efficiency, storage space, and/or processing power. Although embodiments of the present disclosure are described with reference to a Hadoop cluster, it will be appreciated that any type of distributed processing system may be used in the alternative. In one embodiment, Hadoop cluster 304 may be configured to perform a method of identifying demand trends, as will be described in more detail with respect to FIG. 12, so as to generate an output including trends and other demand data.

Demand system 106 may also include a trends loader server 306, which includes one or more servers configured to receive outputs from processes performed by Hadoop cluster 304 and send such outputs to a master database 308 and/or indexed database 310. Master database 308 may be any suitable type of large scale data storage device, which may optionally include any type or combination of slave databases, load balancers, dummy servers, firewalls, back-up databases, and/or any other desired database components. In one embodiment, indexed database 310, may be implemented as Solr/Tomcat databases, and/or any other enterprise search servers. For example, indexed database 310 may include a contextual index, such as a Lucene/Solr distributed index, Sphinx distributed index, or Lemur/Indri distributed index. These components may be used for indexing of text content. Although not necessary, for performance reasons, it may be desired that the size of individual index shards is such that each shard can be stored in main memory on its node. Indexed database 310 may also be distributed MySQL servers (e.g., servers on multiple nodes used for partitioning or replication purposes). In one exemplary embodiment, the indexed database 310 may be single-node MySQL servers used to store medium-sized data sets for analysis, reporting/presentation, and other purposes. The data stored in such a server may be used to build an interface directed towards APIs of demand consumers, demand analysts, and/or business and sales entities.

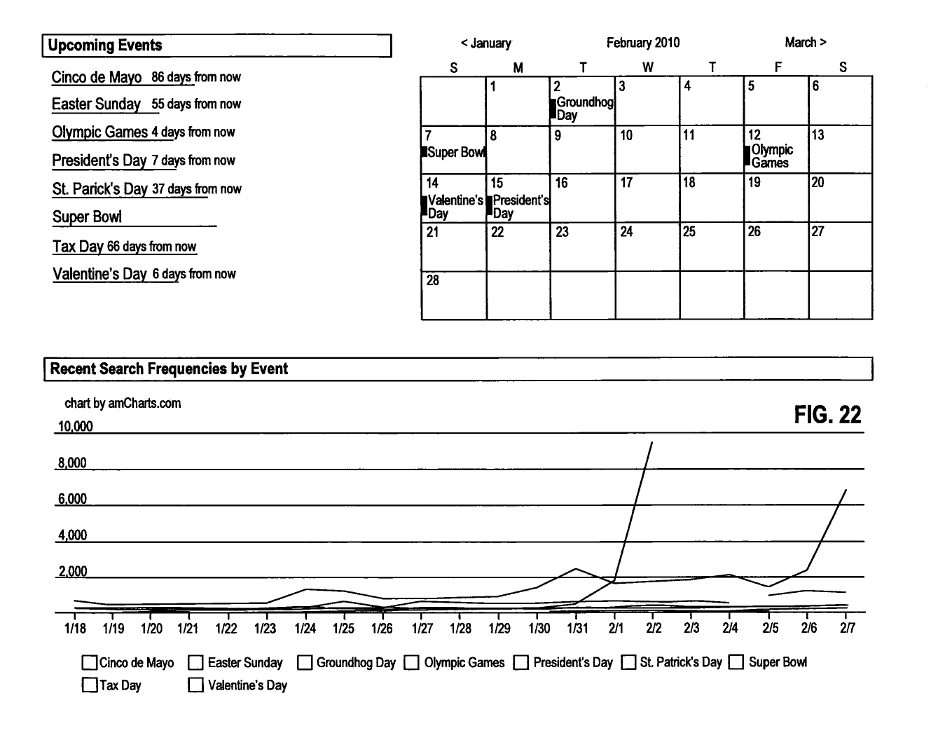

Demand system 106 may also include an application programming interface (“API”) server 310, which includes a demand API 312 and an events API 314, and any other APIs, such as one or more client APIs 316. Events API 314 may serve all entities that are related to events that are time-based or seasonal. These events and their related trending terms can typically be displayed on a calendar, as will be described in more detail below with respect to FIG. 22. The underlying data also supports making predictions based on seasonality and by the fact there are forthcoming events based on a calendar. For instance, “thanksgiving” does not occur on the same day every year but can be correctly predicted based on the trends of the past year corrected for when it would occur in the future years. Demand API 312, events API 314, and/or client API 316 may implement one or more of Tomcat or Java servlets, for example, for responding to HTML requests. Moreover, demand API 312, events API 314, and/or client API 316 may be configured to query master database 308 and/or indexed database 310 for trends or other demand data fetched by trends loader 306 from Hadoop cluster 304.

Demand system 106 may also include a tools server 320, which is configured to submit XML/HTTP queries to the API server 310. In one embodiment, tools server 320 may include demand tools 322, among any other desired client tools 324. Tools server 320 may also be configured to receive inputs from external sources 326. For example, in one embodiment, tools server 320 may be configured to receive inputs from a related search server 328, which generates related search terms. An example of a related search server is disclosed in U.S. patent application Ser. No. 12/791,481, filed on Jun. 1, 2010, by Sean Timm and Sudhir Achuthan, the entirety of which is incorporated herein by reference.

Demand tools 322 may be configured to query API server 310 to obtain lists of trending terms, content topics, categorized topics, trending questions, trending superlatives, trending news, etc. References to “trending” terms may include terms that are increasing in popularity by virtue of increasing user activities on the Internet, including increasing numbers of related searches, clicks, impressions, conversions, toolbar clicks, website visits, social networking messages, etc. In one embodiment, trending topics may be referred to as “accelerating,” which may mean that the volume of such items is increasing over time. Thus, demand tools 322 may be configured to generate outputs regarding high-demand content topics of interest to users 120, contractors 122, and/or editors 124, as well as to various components of content management systems 102. For example, content topics and/or trending terms identified by demand tools 322 of demand system 106 may be used by pricing system 108 and/or assignment system 110 to create and assign content requests.

Referring now to FIG. 12, as described above, Hadoop cluster 304 may perform a method 1200 of identifying demand trends. In one embodiment, method 1200 may begin with receiving raw log data (step 1202). For example, Hadoop cluster 304 may receive query logs, impression/click/conversion logs, proxy logs, toolbar logs, social sharing data, data from URL shorteners, and/or social networking feeds from one or more of search engines 150, ad servers 152, email servers 154, and web servers 156, via log pull server 302. In one embodiment, Hadoop cluster 304 may also receive “Twitter feeds,” external classifer/trender feeds (e.g., information from third-parties regarding popular Internet activities/content), logs purchased from ISPs or other third parties, and browser information, among other sources.

Method 1200 may also include filtering log data (step 1204). For example, method 1200 may filter out certain log data to improve or otherwise generate more useful demand trend results. Log data that may be filtered includes data relating to adult material, such as pornography; personally identifiable information (“PII”), such as names, social security numbers, etc.; so-called non-organic terms, such as navigational queries (e.g., searches for “Facebook,” “YouTube,” etc.); canned searches generated by third-party websites, promoters, or spammers; and URLs (e.g., www.cnn.com). Such data may be removed because it reflects a desire to visit a particular website as opposed to content relating to a topic associated with the query. Such data may also be filtered out because it relates to content that will not be appropriate for UGC methods associated with content management systems 102.

Method 1200 may aggregate the filtered log data by time and/or date (step 1206). For example, method 1200 may compile data into groups based on one or more predetermined periods of time, such as hourly, daily, or even weekly ranges. The aggregation of filtered log data by time and/or date may facilitate the comparison of volumes of data for identifying trends, as will be described in more detail below.

Method 1200 may also include filtering the aggregated data (step 1208). For example, method 1200 may include removing outliers of high and low volumes of traffic. As an example, it may be of little value to track queries, clicks, etc. that only occur a few times per week. Thus, in one embodiment, method 1200 may include removing any log data that does not occur at least 100 times in one day. Likewise, it may be of little value to track queries, clicks, etc. that occur in such high volumes that they likely represent either navigational traffic (e.g., millions of people search for Facebook every week but they do not desire content about Facebook) or bot-like traffic (e.g., traffic having less than 10% click-through rate and/or coming from non-diverse sources). Thus, method 1200 may implement junk traffic filters, including a query frequency minimum threshold, an invocation type ratio threshold, a CTR threshold, and/or a unique user threshold. In one embodiment, queries may be assumed to be navigational, and therefore filtered out, if they contain a URL.

In one embodiment, filtering may not only remove negative queries and data that are undesirable, but it may also selectively highlight queries of greater interest. For example, method 1200 may include extracting queries that include questions or superlatives, with the understanding that queries including questions or superlatives are more frequently indicative of a desire that can be fulfilled with content and typically not navigational queries. For example, questions may be extracted by searching for queries having words like, “what,” “are,” “did,” “is,” “where,” “when,” “how,” “who,” “whom,” “which,” “whose,” “can,” “should,” “could,” or “would.” Superlatives may be extracted by searching for queries having words like, “top,” “amazing,” “best,” “worst,” “lightest,” “heaviest,” “fastest,” “cheapest,” “most,” “hardest,” “easiest,” “lowest,” “newest,” “coolest,” etc.

Method 1200 may also include calculating trends (step 1210). For example, method 1200 may include calculating trend periodicity, calculating historical volumes and acceleration, and/or identifying trends as either “reactive” “evergreen” or “predictive.” Reactive trends may be those that have immediate urgency due to interest being likely to expire soon or due to the space being highly competitive. Evergreen trends may be those that have regular and significant levels of interest, and do not have a determinable expiration date (i.e., they are independent of seasonality). Predictive trends may be highly predictable and repeating at regular intervals

For reactive trends, a daily reactive trend score for yesterday, T₋₁, may be calculated based on the difference between yesterday's frequency (λ₋₁) and the approximate 3 week daily moving average (Φ_{d}) for a given query, where ₋₁ indicates the day before today. The score may be defined by the formula:

$${T}_{- 1} = log ( \frac{{Λ}_{- 1}}{Φ} ) \times log ( {Λ}_{- 1} - Φ )$$

$$where \text{:}$$

$$Φ = \frac{{\sum }_{n = - 21}^{- 2} {Λ}_{n}}{20} .$$

The hourly reactive trend score for the last hour, T₋₁, may be based on the difference between the last hour's frequency (λ₋₁), and the normalized˜72 hour moving average (φ) for a given query. Since there may be less traffic in the early morning than there is in the early evening, the expected value for the moving average may be normalized for comparison to the current hour, where ₋₁ indicates one hour before now, as defined by the formulas:

$${τ}_{- 1} = log ( \frac{{λ}_{- 1}}{φ} ) \times log ( {λ}_{- 1} \times norm - φ )$$

$$where \text{:}$$

$$norm = \frac{{\sum }_{λ}}{\frac{{\sum }_{λ} {\sum }_{n = - 72}^{- 2} {λ}_{n}}{71}}$$

$$and$$

$$φ = ( \frac{{\sum }_{n = - 72}^{- 2} {λ}_{n}}{72} ) \times norm .$$

For custom scopes, trend scores may be summed over the requested range using the requested interval, defined as follows:

$$Daily \text{:} {T}_{c} = {\sum }_{d = N}^{M} {T}_{d}$$

$$Hourly \text{:} {τ}_{c} = {\sum }_{h = N}^{M} {τ}_{h}$$

The method may also include normalizing between day of week or monthly fluctuations, similar to hourly fluctuations, as described above.

Finally, method 1200 may include sorting and/or categorizing trends based on based on subject matter (step 1212), and optionally creating a corresponding “click graph.” Any suitable categorization or clustering techniques may be used to group trends by subject matter, such as Wikipedia-based categorization, DMOZ-based categorization, and/or Freebase-type categorization. Queries may also be categorized based on patterns of associated URLs and related queries. In one embodiment, method 1200 may include generating a click graph that displays a primary query topic, and related queries grouped in branches according to their relationship with each other and the primary query topic. Method 1200 may also include sorting and/or categorizing trends based on geographical, or “geo-local” classifications. For example, trends or demand terms may be further classified based on their geographical origins. Also, geo-local trends can be based off of a local calendar, e.g., such as trends related to events/performances scheduled in the Kennedy Center (for DC).

FIG. 13 displays an exemplary click graph for “Thanksgiving,” consistent with embodiments of the present disclosure. Such click graphs may assist contributors and editors in identifying related terms and concepts, and understand relationships between terms and concepts. Thus, if a term is identified as trending or popular, a click graph of the term may reveal related content that could be generated in addition to content solely concerning the topic, which may be of great value to content sites and advertisers.

Referring back to FIG. 12, sorted and/or categorized trends may be used to display queries and/or trends in an editorial console (step 1214). For example, demand system 106 may automatically populate the editorial console with a list of trending terms or trending queries, related search terms, related videos, related questions and superlatives, related clicked URLs, related news headlines/stories, etc. In addition, or alternatively, the sorted and/or categorized trends may be used to automatically generate content requests based on calculated trends and/or queries (step 1216).

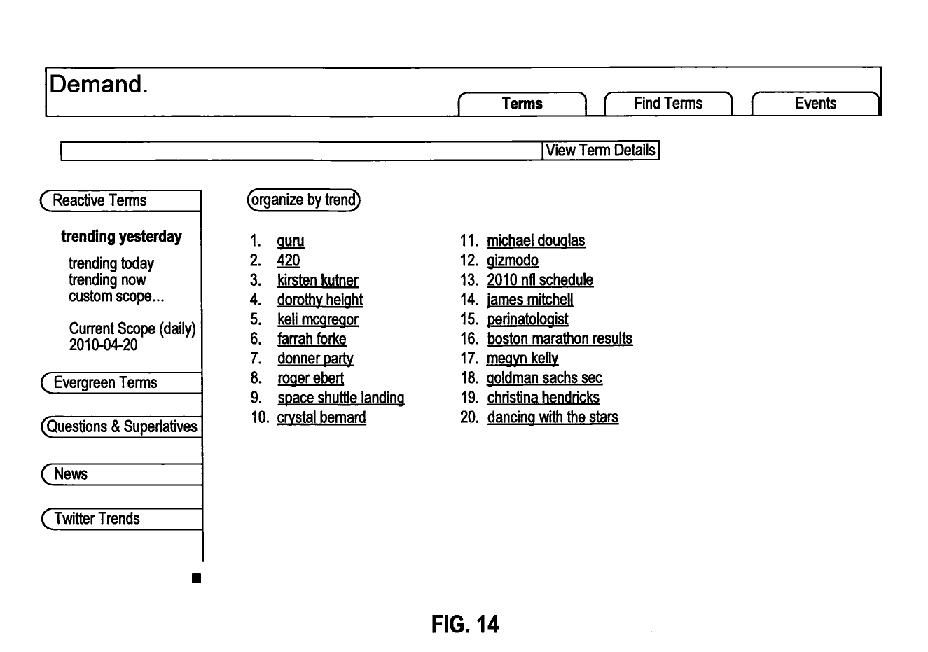

FIG. 14 depicts a screenshot of an exemplary demand editorial console that may be generated by demand system 106, the editorial console showing a list of fifty (50) reactive terms, which are populated by demand tools 322 of demand system 106. As shown in FIG. 14, an editor may view reactive terms by those “trending yesterday,” “trending today,” “trending now,” or “custom scope.” Furthermore, an editor may selectively view reactive terms organized “by trend” or “by category.”

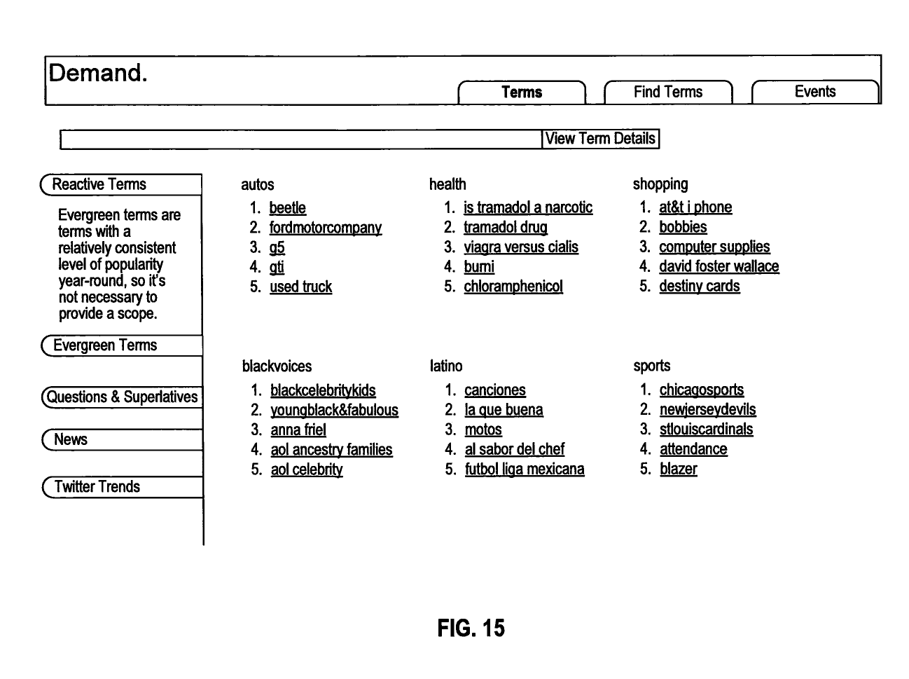

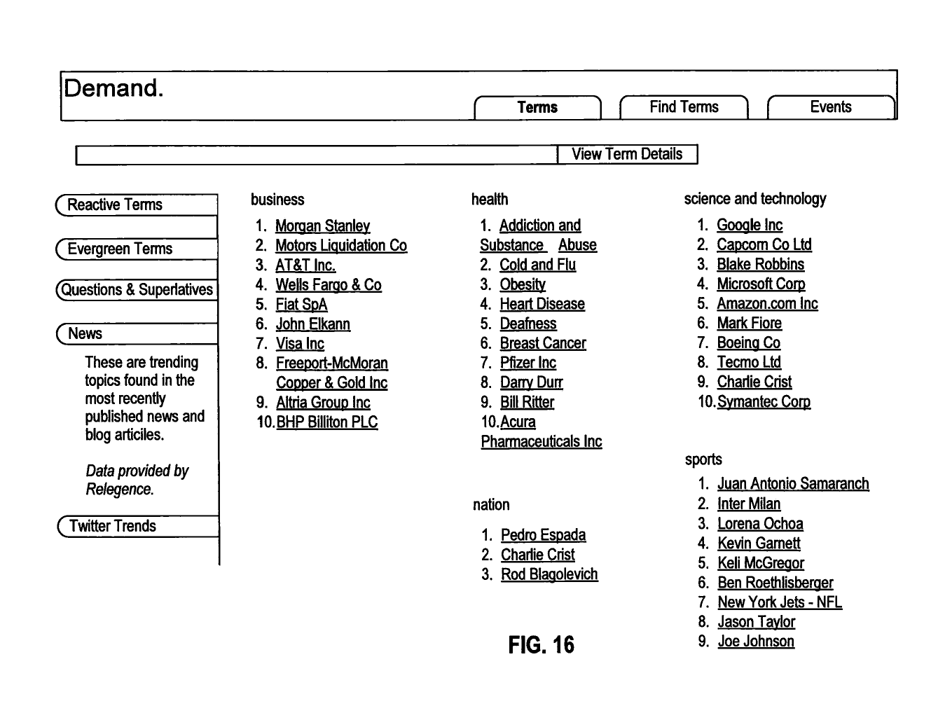

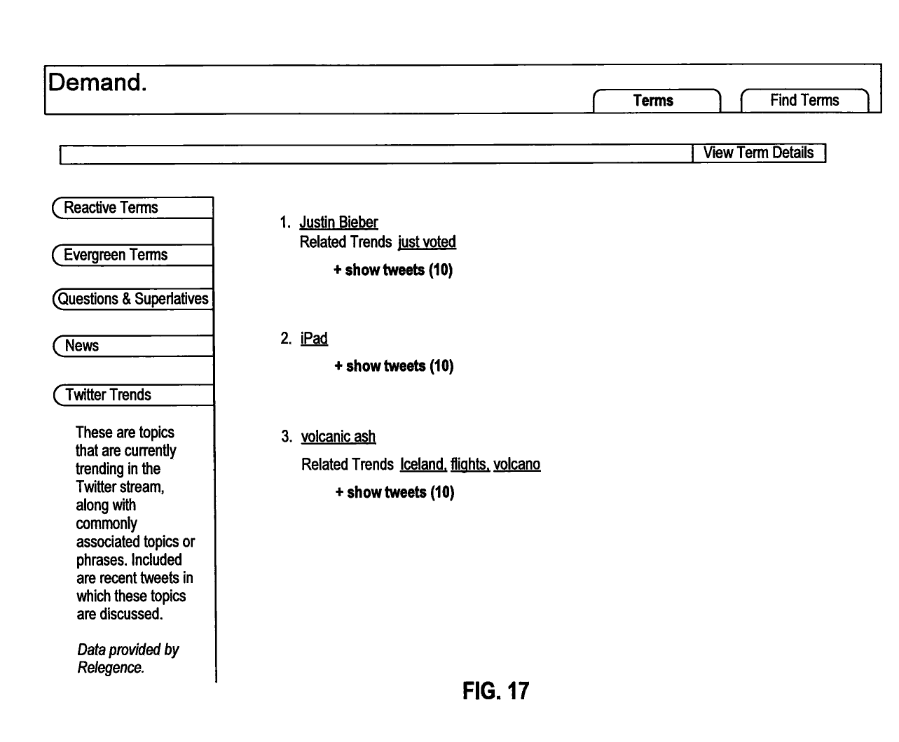

FIG. 15 depicts a screenshot of an exemplary demand editorial console showing a plurality of evergreen topic categories, and a listing of evergreen terms under each topic category. FIG. 16 depicts a screenshot of an exemplary demand editorial interface showing a set of news trending topic categories, and a listing of news trending topics under each topic category. FIG. 17 depicts a screenshot of an exemplary demand editorial interface showing a set of recent trending terms, such as Twitter Trends, which may be generated by demand system 106.

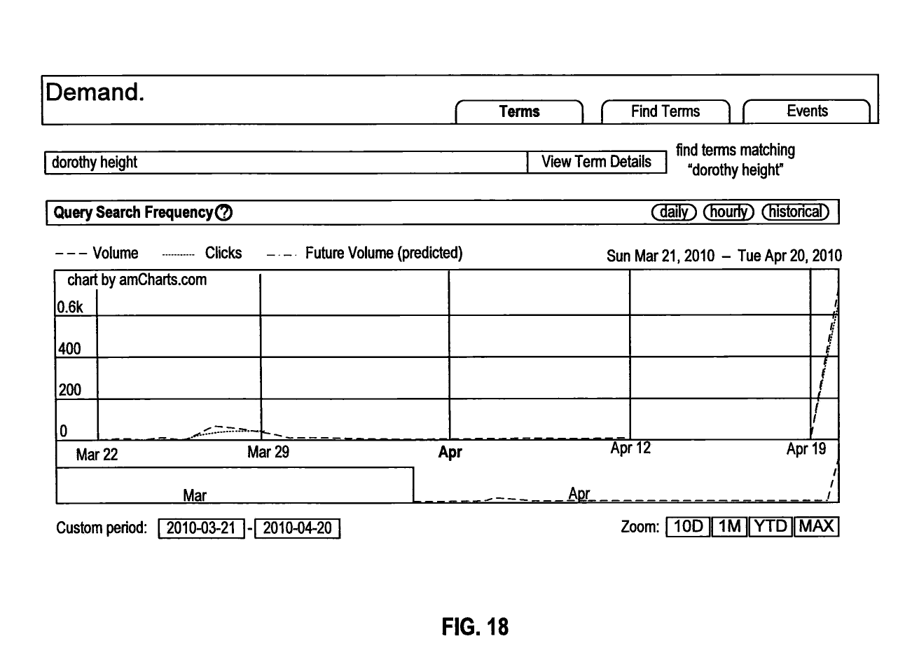

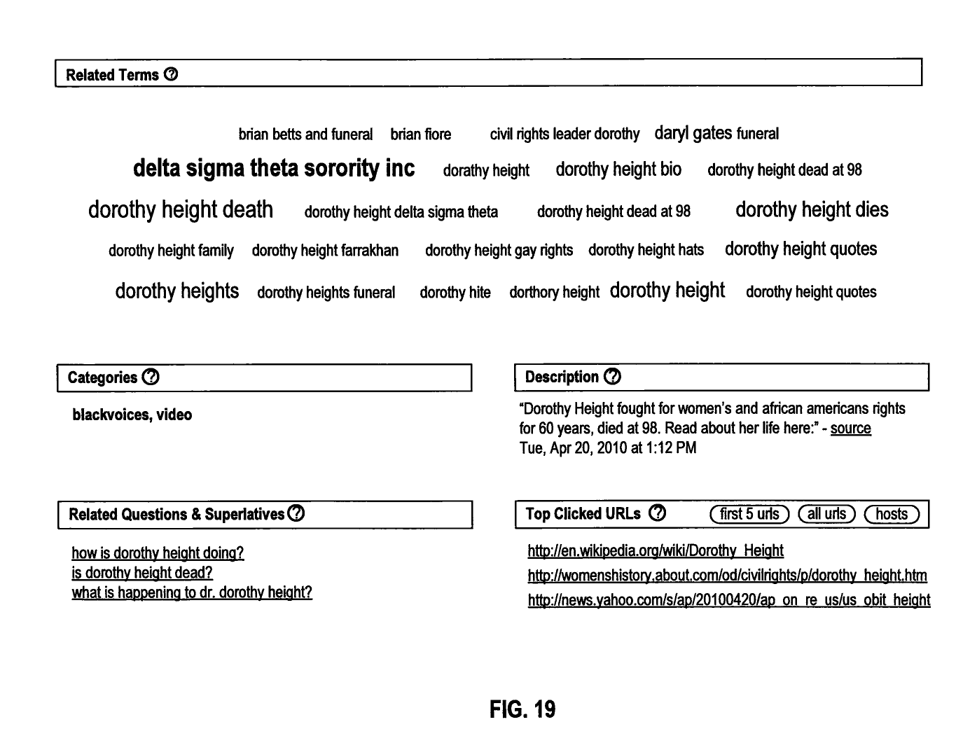

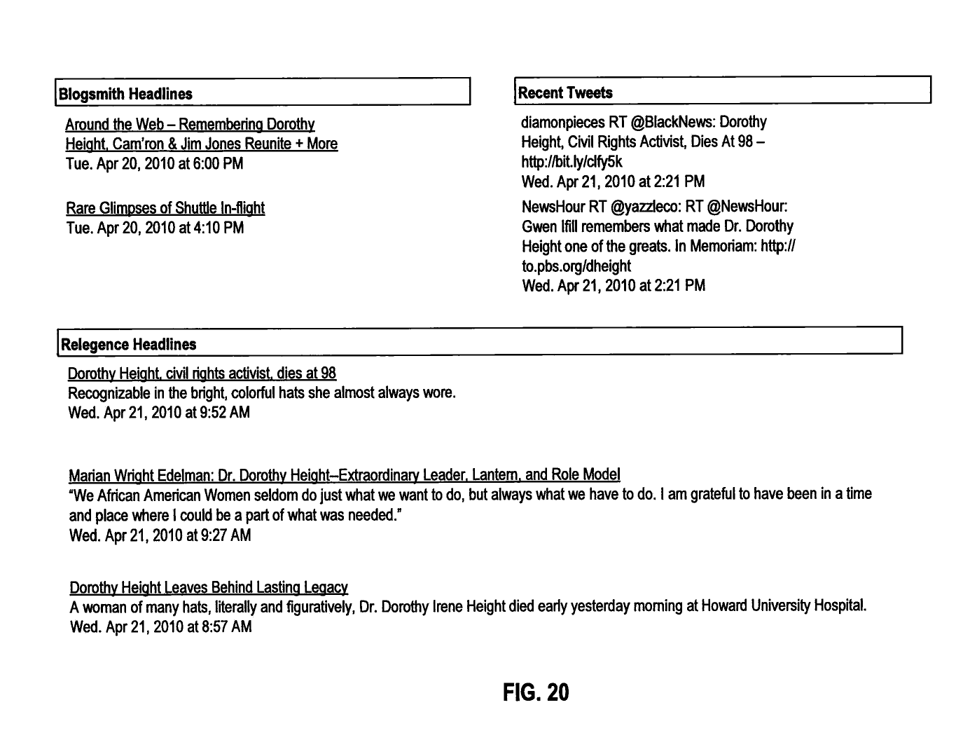

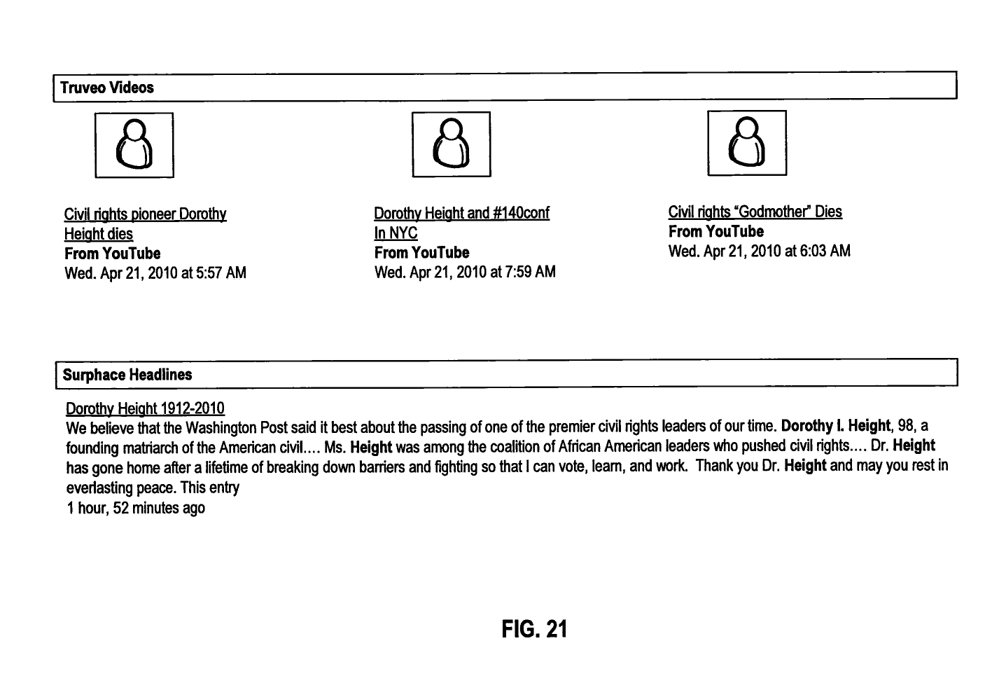

FIG. 18 is a partial screen shot of an editorial console, including a graph of one exemplary trending term tracked by demand system 106, which in this case happens to be the name of an individual who passed away on Apr. 20, 2010. The graph in FIG. 18 shows an example of how the volume of queries and clicks associated with the individual increased dramatically on the day of the individual's death. Because the spike in volume was unpredictable, sudden, and dramatic, it represents an example of a reactive trending term, for which user generated content is desired immediately. In addition to a graph of internet volume, the editorial portal may include additional information about the trending term, which may be referred to as trend metadata. For example, FIG. 19 depicts a screen shot of related terms, categories, a description, related questions & superlatives, and top clicked URLs associated with the exemplary trending term tracked by the demand system. In addition, FIG. 20 is a screen shot of headlines and messages associated with the exemplary trending term tracked by the demand system, while FIG. 21 depicts a screen shot of videos and additional headlines associated with the exemplary trending term tracked by a demand system. As described above, certain related terms, headlines, videos, messages, etc. may be received by demand system 106 from external sources 326.

FIG. 22 is a screen shot of an exemplary calendaring console generated by demand system 106. The calendaring console may generate and display a list of upcoming events, based on historical data, recent search frequencies by event, and processed log data. The calendaring console may also display upcoming events on a calendar that can be displayed to editors and/or contributors.

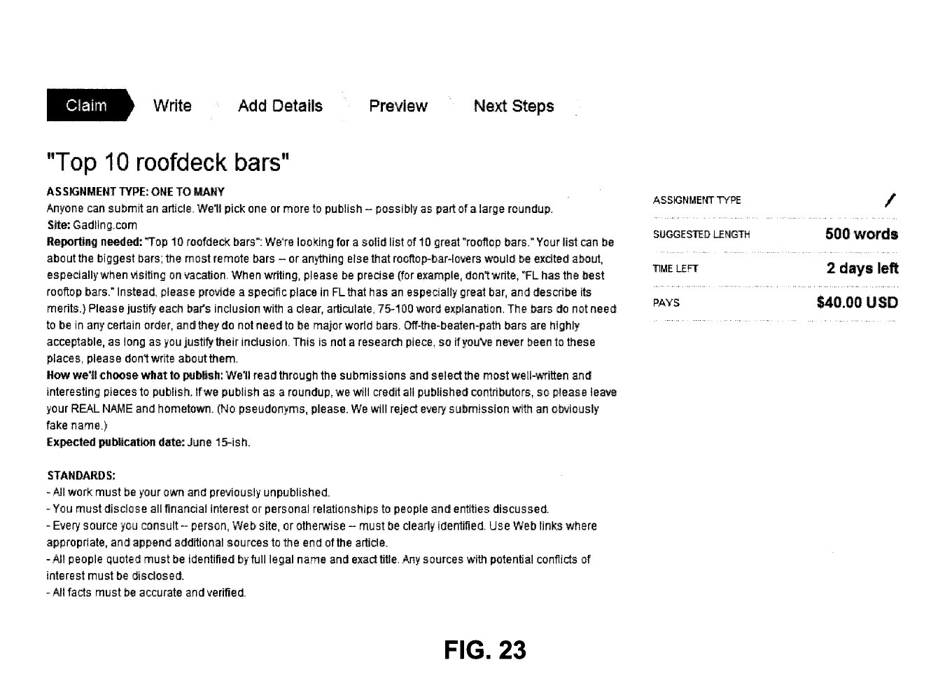

FIG. 23 is a screen shot of an exemplary content request generated by demand system 106. As described above, the content request may be an electronic data file that includes a title, an assignment type, a description, standards, a suggested length, a time remaining to claim the content request, and/or an offer price. The electronic data file may be distributed to contributors by any desired communication means, as described above, and/or accessed via open CMS website 128. A contributor may claim the content request, create content that satisfies the content request, add details to the content, preview the content, and then submit the content for review and publishing.

The many features and advantages of the present disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A computer-implemented method for managing electronic content, the method including:
receiving, over an electronic network, log data of activities by Internet users;
filtering the log data based on at least one aspect of the activities;
aggregating the filtered log data by a predetermined period of time;
calculating a trend concerning one or more keywords associated with the aggregated log data, based on a change in a volume of the activities; and
presenting to an editor, over the electronic network, an editorial console including a topic associated with the calculated trend and metadata related to the topic.

2. The method of claim 1, wherein the metadata includes at least one of related search terms, related questions and superlatives, related news stories, related videos, related headlines, or related clicked URLs.

3. The method of claim 1, wherein the electronic content includes at least one of: text, images, audio tracks, video tracks, computer programs, articles, blog posts, photos, recordings, videos, software, or games.

4. The method of claim 1, wherein the log data includes at least one of:
query logs, impression logs, click logs, conversion logs, proxy logs, toolbar logs, or social networking feeds.

5. The method of claim 1, wherein the activities by Internet users includes at least one of: entering search queries, viewing web pages, viewing online advertisements; clicking on links, clicking on online advertisements, interacting with web pages, interacting with toolbars, interacting with web browsers, or interacting with social networking sites.

6. The method of claim 1, wherein the at least one aspect of the activities includes a content of adult material, personally identifiable information (“PII”), non-organic terms, navigational queries, canned searches, or URLs.

7. The method of claim 1, wherein the filtering includes filtering based on at least one of a junk traffic filter, a query frequency minimum threshold, an invocation type ratio threshold, a CTR threshold, or a unique user threshold.

8. The method of claim 1, wherein aggregating the filtered log data by a predetermined period of time includes grouping the filtered log data into at least one of hourly or daily ranges.

9. The method of claim 1, wherein the change of the activities includes increasing volumes of one or more of: entering search queries, viewing web pages, viewing online advertisements; clicking on links, clicking on online advertisements, interacting with web pages, interacting with toolbars, interacting with web browsers, or interacting with social networking sites.

10. The method of claim 1, further comprising:
displaying a request to a contributor over the electronic network, the request soliciting a submission of electronic content relating to the topic associated with the calculated trend;
wherein presenting the request includes sending a content request by one or more of: telephone, facsimile, email, SMS or MMS text message, social networking message, VOIP, website, podcast, chat room, message board, listserv, media stream, or electronic broadcast.

11. The method of claim 10, wherein the method further comprises receiving from a contributor, over the electronic network, a submission of electronic content in response to the request.

12. The method of claim 11, further comprising:
displaying the submission of electronic content to users of the Internet;
delivering online advertisements in association with the submission of electronic content;
receiving advertising revenue in relation to delivery of the online advertisements; and
sending a portion of the advertising revenue to the contributor.

13. A computer-implemented method for managing electronic content, the method including:
receiving, over an electronic network, log data of activities by Internet users, the log data including at least one of proxy data, search queries, or URLs;
filtering the log data based on at least one aspect of the activities;
aggregating the filtered log data by a predetermined period of time;
calculating a trend concerning one or more keywords associated with the aggregated log data, by comparing a volume of the aggregated log data concerning one of the keywords to a historical volume of activities concerning the one of the keywords; and
presenting to an editor, over the electronic network, an editorial console including a topic associated with the calculated trend and metadata related to the topic.

14. The method of claim 13, wherein the metadata includes at least one of related search terms, related questions and superlatives, related news stories, related videos, related headlines, or related clicked URLs.

15. A system for managing electronic content, the system including:
a server configured to receive, over an electronic network, log data of activities by Internet users;
a processor configured to:
filter the log data based on at least one aspect of the activities;
aggregate the filtered log data over a predetermined period of time; and
calculate a trend concerning one or more keywords associated with the aggregated log data, based on a change in a volume of the activities; and
a web server configured to present to an editor, over the electronic network, an editorial console including a topic associated with the calculated trend and metadata related to the topic.

16. The system of claim 15, wherein the electronic content includes at least one of: text, images, audio tracks, video tracks, computer programs, articles, blog posts, photos, recordings, videos, software, or games.

17. The system of claim 15, wherein the log data includes at least one of:
query logs, impression logs, click logs, conversion logs, proxy logs, toolbar logs, or social networking feeds.

18. The system of claim 15, wherein the Internet user activities includes at least one of: entering search queries, viewing web pages, viewing online advertisements; clicking on links, clicking on online advertisements, interacting with web pages, interacting with toolbars, interacting with web browsers, or interacting with social networking sites.

19. The system of claim 15, wherein the at least one aspect of the activities includes a content of adult material, personally identifiable information (“PII”), non-organic terms, navigational queries, canned searches, and URLs.

20. The system of claim 15, wherein the processor is configured to filter based on at least one of: a junk traffic filter, a query frequency minimum threshold, an invocation type ratio threshold, a CTR threshold, or a unique user threshold.

21. The system of claim 15, wherein the processor is configured to aggregate the filtered log data by a predetermined period of time, by grouping the filtered log data into at least one of hourly or daily ranges.

22. The system of claim 15, wherein the rate of change of the activities includes increasing volumes of one or more of: entering search queries, viewing web pages, viewing online advertisements; clicking on links, clicking on online advertisements, interacting with web pages, interacting with toolbars, interacting with web browsers, or interacting with social networking sites.

23. The system of claim 15, wherein the web server is configured to present the request to the contributor over the electronic network, by sending a content request by one or more of: telephone, facsimile, email, SMS or MMS text message, social networking message, VOIP, podcast, chat room, listserv, media stream, or electronic broadcast.

24. The system of claim 15, wherein the web server is configured to present the request to the contributor over the electronic network, includes displaying the request on a website or message board.

25. The system of claim 15, wherein the web server is configured to receive from a contributor, over the electronic network, a submission of electronic content in response to the request.

26. The system of claim 25, further comprising:
a second web server configured to display the submission of electronic content to users of the Internet; and
an ad server configured to deliver online advertisements in association with the submission of electronic content.
